(19) United States
(12) Patent Application Publication
(10) Pub. No.: US 2018/0223681 A1
(43) Pub. Date: Aug. 9, 2018

(54) TURBINE ENGINE SHROUD WITH NEAR WALL COOLING

(71) Applicant: General Electric Company, Schenectady, NY (US)

(72) Inventors: Kirk D. Gallier, Cincinnati, OH (US); Robert Charles Groves, II, West Chester, OH (US)

(21) Appl. No.: 15/428,722

(22) Filed: Feb. 9, 2017

(51) Int. Cl. F01D 9/04; F04D 29/32; F04D 29/52; F04D 29/58; F04D 29/54; F01D 5/02; F01D 25/12; F02C 3/04

(52) U.S. Cl. CPC F01D 9/041; F04D 29/324; F04D 29/526; F04D 29/582; F04D 29/542; F01D 5/02; F05D 2300/6033; F02C 3/04; F05D 2220/32; F05D 2230/10; F05D 2230/50; F05D 2230/22; F05D 2240/35; F01D 25/12

(57) ABSTRACT

An apparatus for a shroud assembly for a turbine engine and a method of manufacturing such can include the shroud assembly having one or more shroud segments having an inner face in a circumferential organization around a rotating blade assembly. A near wall cooling passage can be provided in the shroud assembly to cool the inner face of the shroud. The near wall cooling passage can exhaust to a purge cavity, a split line, or at the inner face.

### BACKGROUND OF THE INVENTION

Turbine engines, and particularly gas or combustion turbine engines, are rotary engines that extract energy from a flow of combusted gases passing through the engine onto a multitude of rotating turbine blades.

Gas turbine engines include a plurality of circumferentially driven blades, organized into multiple stages, to move a volume of airflow through the gas turbine engine to generate thrust. A shroud assembly, forming a portion of the casing for the gas turbine engine, surrounds the blades. The shroud assembly is formed of a plurality of shroud segments, interconnected to form the circumferential shroud assembly.

### BRIEF DESCRIPTION OF THE INVENTION

In one aspect, the present disclosure relates to a shroud assembly for a turbine engine having an engine centerline. The shroud assembly includes at least one segment including a body having a forward face and an aft face. The segment further includes a radially inner face, which faces the engine centerline and a radially outer face facing away from the engine centerline. A near wall cooling passage is provided in the segment and has an inlet provided in the outer face and an outlet.

In another aspect, the present disclosure relates to a turbine engine including a compressor section, a combustion section, and a turbine section in axial arrangement and defining an engine centerline. A blade assembly is provided in at least one of the compressor section or the turbine section and includes a rotatable disk having a plurality of circumferentially arranged blades extending radially from the disk relative to the engine centerline. A shroud assembly surrounds and is spaced from the blade assembly, and includes multiple, circumferentially-arranged ceramic matrix composite (CMC) shroud segments. At least one shroud segment is formed from a plurality of layered CMC plies with at least some of the plies having apertures. At least one near wall cooling passage is formed by the apertures in the plurality of layered plies.

In yet another aspect, the present disclosure relates to a method of manufacturing a ceramic matrix composite (CMC) component for a turbine engine, including: (1) forming apertures in at least some of a plurality of CMC plies; (2) layering the plurality of plies to form the CMC component with the apertures forming a cooling passage; and (3) hardening the component.

### BRIEF DESCRIPTION OF THE DRAWINGS

In the drawings:

FIG. 1 is a schematic cross-sectional diagram of a gas turbine engine for an aircraft.

FIG. 2 is a schematic view of a turbine section of the gas turbine engine of FIG. 1

FIG. 3 is schematic view of a shroud of the turbine section of FIG. 2 with a near wall cooling passage defined by the shroud having a first portion and a second portion.

FIG. 4A is a view of an exemplary ply taken from the first portion of FIG. 3.

FIG. 4B is a view of another exemplary ply taken from the first portion of FIG. 3.

FIG. 4C is a view of yet another exemplary ply taken from the second portion of FIG. 3.

FIG. 5 is schematic view of another shroud of the turbine engine of FIG. 2, with a near wall cooling passage system defined by the shroud assembly having three portions.

FIGS. 6A-6C are views of three plies that can be reflective of the three portions of FIG. 5.

FIG. 7 is a top schematic view of two airfoils shown in dashed-line underneath a shroud assembly illustrating a throat between the two airfoils and a near wall cooling passage.

FIG. 8 is a perspective view of a shroud assembly having multiple segments with splines between adjacent segments.

FIG. 9 is a flow chart illustrating a method of manufacturing a ceramic matrix composite (CMC) component for a turbine engine.

### DETAILED DESCRIPTION OF THE INVENTION

Aspects of the disclosure described herein are directed to a component for a turbine engine, such as a shroud, having near wall cooling passages and a method of forming thereof. For purposes of illustration, the present disclosure will be described with respect to a shroud located in the turbine for an aircraft gas turbine engine. It will be understood, however, that aspects of the disclosure described herein are not so limited and may have general applicability within an engine, including compressors, as well as in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component.

Additionally, as used herein, the terms “radial” or “radially” refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

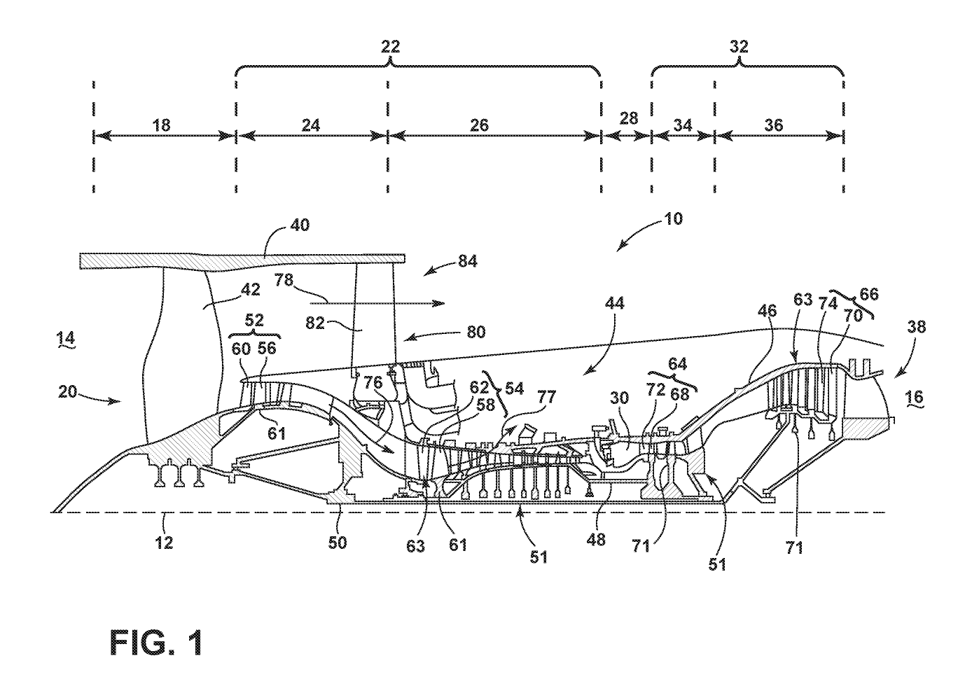

FIG. 1 is a schematic cross-sectional diagram of a gas turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle in turbine hardware) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to a disk 61, which is mounted to the corresponding one of the HP and LP spools 48, 50, with each stage having its own disk 61. The vanes 60, 62 for a stage of the compressor can be mounted to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to the corresponding one of the HP and LP spools 48, 50, with each stage having a dedicated disk 71. The vanes 72, 74 for a stage of the compressor can be mounted to the core casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized airflow 76 to the HP compressor 26, which further pressurizes the air. The pressurized airflow 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be drawn from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine assembly 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

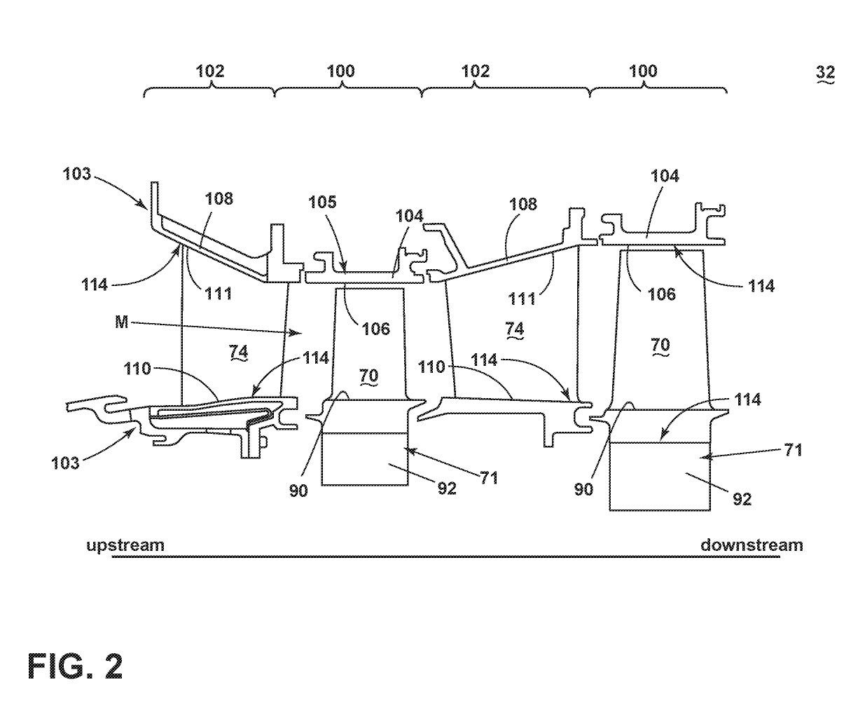

FIG. 2 illustrates a view of a portion of the turbine section 32 of FIG. 1. While illustrated in reference to the turbine section 32, such aspects as described herein can have similar applicability to a compressor section 22, as well as a HP turbine, LP turbine, HP compressor, or LP compressor. The turbine section 32 as shown can be separated into rotor sections 100 and stator sections 102. The rotor sections 100 include the rotating blade 70 coupled to the rotating disk 71. It should be appreciated, however, that rotating elements can extend into the stator section 102, stationary elements can extend into the rotor section 100, and that the rotor and stator sections 100, 102 are generally representative of the rotating blades 70 and the stationary vanes 74, respectively, forming stages of the turbine section 32. A platform 90 can define a radial terminal surface for the disk 71. The platform 90 can provide a circumferential surface for mounting the blades 70 to the disk 71. The platform 90 can at least partially define the mainstream flow path M. The disk 71 can also terminate in a dovetail 92, where the blade 70 mounts to the dovetail 92 at the platform 90. Alternatively, the platform 90 can be an outer radial wall of the disk 71 to which the blade 70 mounts, or can alternatively be a radially outwardly facing surface formed in an integral blade and disk structure.

A peripheral assembly 103 can include a shroud 104, which radially encases the blades 70 and the disk 71, an outer band 108, which encases the vanes 74, an inner band 110, and the disk 71 to which the blades 70 attach. The peripheral wall assembly 103 can extend in a substantially axial direction defining a mainstream flow path M extending through the turbine section 32. The shroud 104 can be formed of a plurality of shroud segments 105 in circumferential arrangement. An inner face 106 of the shroud 104 faces radially inward, relative to the engine centerline 12 (FIG. 1) toward the rotating blades 70. The stator sections 102 include the stationary vanes 74 mounted between the outer band 108 and the inner band 110. The outer band 108 can include an inner face 111 and the inner band 110 can have an outer face 113. The inner face 106 of the shroud 104 and the inner face 111 of the outer band 108 can represent the same interior surface of the peripheral assembly 103 for encasing the blades 70 and the vanes 74 and confronting the mainstream airflow M passing through the engine core. The mainstream flow M can pass along the blades 70 and the vanes 74, and can be driven by the blades 70. The mainstream flow M can be heated, such as by the combustor section, such that components of FIG. 2 may require cooling. The platform 90, the inner face 106 of the shroud 104, the inner face 111 of the outer band 110, and the outer face 113 of the inner band 110 can at least partially define a peripheral wall 114 extending in an axial direction. The peripheral wall 114 confronts the mainstream flow M passing through the peripheral assembly 103 of the turbine section 32.

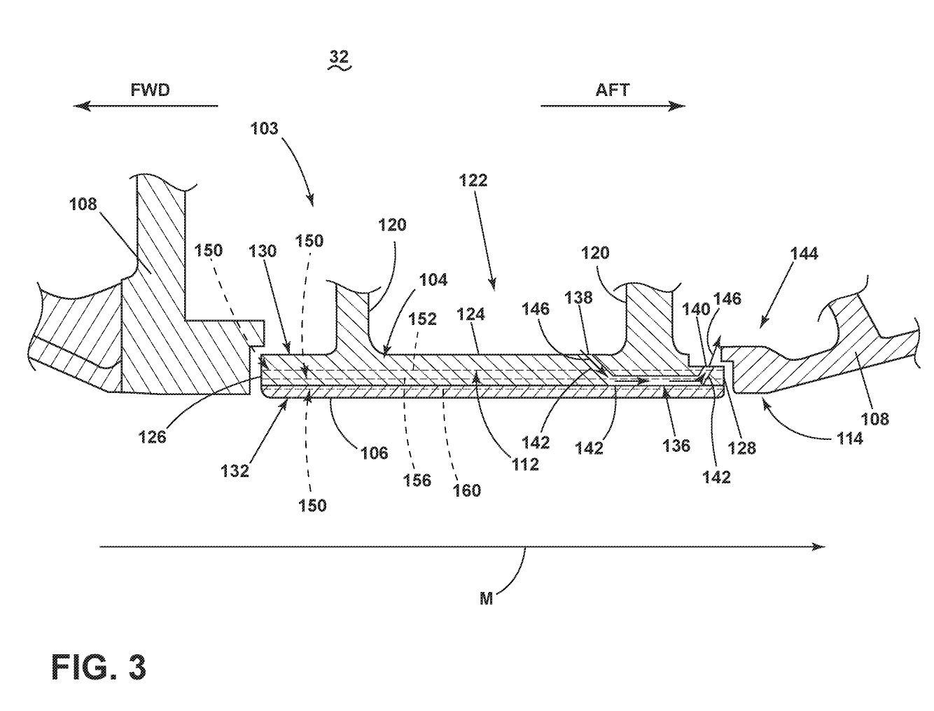

Referring now to FIG. 3, an enlarged portion of the turbine section 32 is shown as one shroud 104 provided between two outer bands 108. It should be appreciated that while FIGS. 3-8 are described in relation to a shroud, the aspects described herein can have equal applicability to an inner band or a nozzle or vane assembly, and outer band of a nozzle or vane assembly, or to a surface to which a blade can mount. The shroud 104 includes a body 112 with two radially outwardly extending rails 120 spaced between a radially outer face 124 to defining a shroud cavity 122. The body 112 includes a forward face 126 and an aft face 128, facing forward and aft, respectively.

The shroud 104 can be separated into a radially outer, first portion 130 and a radially inner, second portion 132. The first portion 130 is positioned radially exterior of the second portion 132. A near wall cooling passage 136 can be formed in the shroud 104, and can be formed in the first portion 130. The near wall cooling passage 136 can include an inlet 138 and an outlet 140 connected by one or more discrete, yet fluidly coupled channels 142. While shown as three discrete channels 142 to form the near wall cooling passage 136, it should be appreciated that any number of channels 142 are contemplated, such as multiple channels, or complex near wall cooling passages 136, are contemplated.

The second portion 132 can partially form the near wall cooling passage 136. As shown, the near wall cooling passage 136 is partially formed as the channel 142 in the first portion 130 and exposed to the second portion 132. The second portion 132 encloses the channel 142 of the near wall cooling passage 136, such that the airflow arrows 146 can impinge upon the second portion 132 within the near wall cooling passage 136.

The near wall cooling passage 136 can fluidly couple the shroud cavity 122 to a purge air cavity 144, as illustrated by airflow arrows 146. It should be appreciated that while the airflow arrows 146 passing through the near wall cooling passage 136 are shown as travelling in a substantially axial and aft direction, that any flow direction is contemplated. Such a flow direction can be forward, aft, axial, radial, circumferential, or any combination thereof, in non-limiting examples. While the near wall cooling passage 136 is formed in the shroud 104, it should be appreciated that the near wall cooling passage 136 can be formed in any portion of the peripheral assembly 103, such as the outer bands 108, the inner band 110, or the platform 90. As such, the near wall cooling passage 136 can be formed in any portion of the peripheral wall 114 as described herein. Similarly, the first and second portions 130, 132 can form the peripheral wall 114 similar to that of the shroud 104.

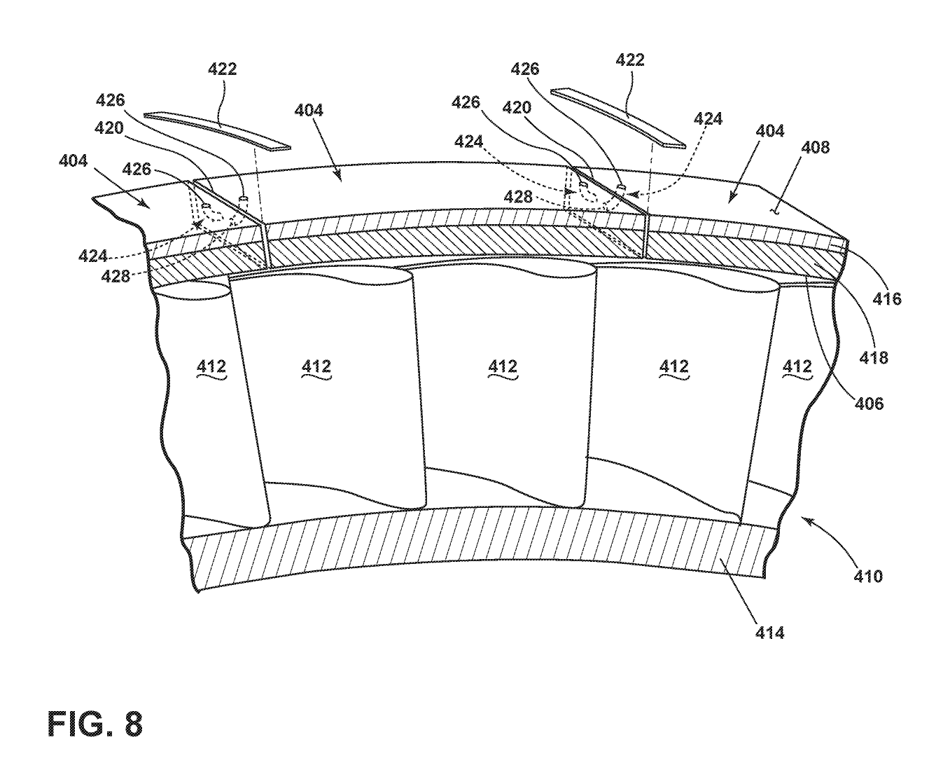

It should be appreciated that while the near wall cooling passage 136 is illustrated as having the outlet 140 exhausting to the purge air cavity 144, other implementations of the near wall cooling passage 136 are contemplated. In additional non-limiting examples, the outlet 140 can be positioned on the outer face 124, exhausting to the shroud cavity 122, can be positioned to exhaust to a split line between adjacent shroud segments (see split line 420, FIG. 8), or exhaust at the inner face 106 to integrate within the mainstream flow M to operate as a cooling fluid along the inner face 106.

Each of the first and second portions 130, 132 can be made of ceramic matrix composite. During assembly, the first and second portions 130, 132 can be separately manufactured, and attached to one another to form the near wall cooling passage 136, such as by sintering or by a ceramic bonding process in non-limiting examples. In a metal application, welding can be used as an attachment method. As such, the first and second portions 130, 132 can be separately tailored, such as the second portion 132 adapted to operate under higher temperatures as it confronts the mainstream flow M.

The shroud 104 can alternatively be made of a plurality of plies 150, illustrated as dashed-lines extending through the first and second portions 130, 132. Three exemplary plies 150 are represented by the dashed-lines, including a first ply 152, a second ply 156, and a third ply 160. The first ply 152 includes channels 142 of the near wall cooling passage 136 adjacent the inlet 138 and the outlet 140 and positioned in the first portion 130. The second ply 156 is provided in the first portion 130 and includes the channel 142 of the near wall cooling passage 136 adjacent the second portion 132. The third ply 160, taken along the dashed line, partially forms the second portion 132 and forms no part of the near wall cooling passage 138. However, it is contemplated that a ply 150 forming the second portion 132 can enclose and partially form the near wall cooling passage 136. The ceramic matrix composite (CMC) shroud 104 can be made of a plurality of the plies. In one example, the plies 150 can be about 0.01 inches thick, and layer a plurality of the plies 150 forms the shroud assembly 104. While only three plies 150 are shown in FIG. 3, it should be understood that the component includes a plurality of plies 150. Furthermore, the plies 150 as described herein can be green-state plies. Green-state plies are soft CMC ply layers that are uncured or unfired, prior to hardening to form the component. It is also contemplated that the shroud 104 can be wholly or partially made of green-state plies, forming all of or only a portion of the shroud 104 at the near wall cooling passage 136, while the remainder of the shroud 104 is made by another method, or pre-made with additional parts or portions added at a later time.

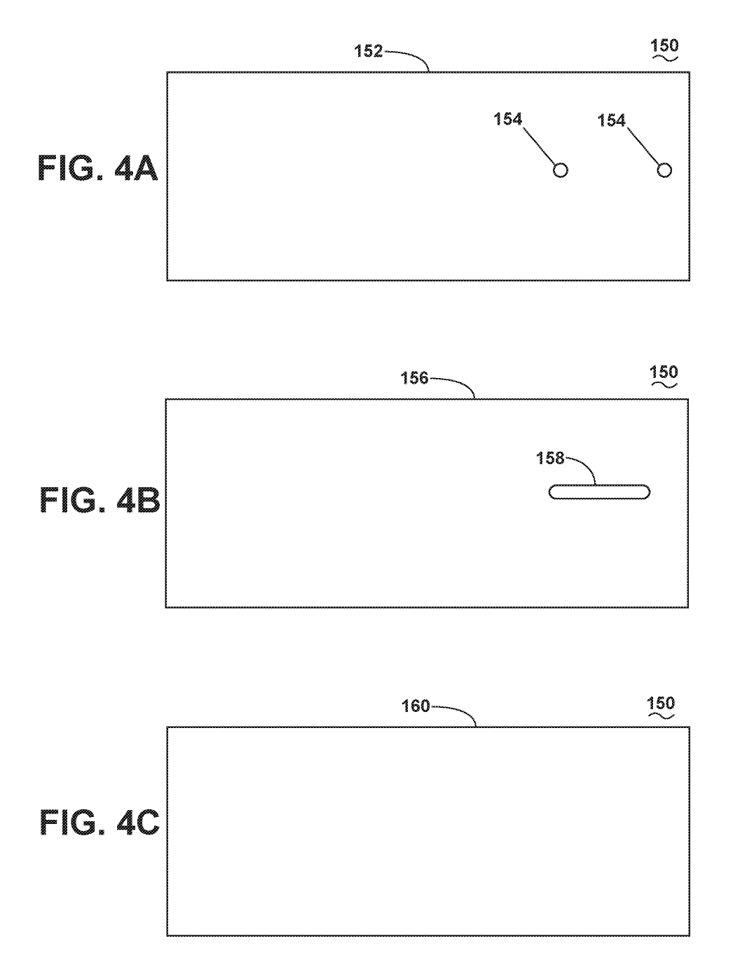

Apertures formed in the plies 150 can be used to form the near wall cooling passage 136. Turning to FIGS. 4A, 4B, and 4C the three exemplary plies 150 are shown, including such apertures, or lack thereof, to form the shroud assembly 104 of FIG. 3 with the near wall cooling passage 136. FIG. 4A, for example, illustrates the first ply 152 and includes two circular apertures 154. The two apertures 154 can be representative of the two separate channels 142 of the near wall cooling passage 136 adjacent the inlet 138 and outlet 140 of FIG. 3. The entire channels 142 can be formed upon layering of multiple plies similar to the first ply 152 having the arranged apertures 154. FIG. 4B illustrates the second ply 156 and includes one elongated aperture 158. The elongated aperture 158 can be representative of the channel 142 of FIG. 3 extending in the axial direction, or a groove formed in one of the portions, for example. FIG. 4C illustrates the third ply 160 having no holes or apertures provided in the ply 160. The third ply 160 can be used to form the second portion 132 of the shroud 104, while it is contemplated that the third play 160 can alternatively enclose the elongated aperture 158 of FIG. 4B when positioned adjacent to second ply 156 to enclose the near wall cooling passage 136 of FIG. 3 as it is formed by the layering of the plies 150.

During assembly of the shroud assembly 104 or the first and second portions 130, 132 of FIG. 3, multiple plies 152, 156, 160 as shown in FIGS. 4A-4C, can be layered such that the plurality of ply layers 150 can form the shroud assembly 104, the first and second portions 130, 132, and the near wall cooling passage 136. In order to form the near wall cooling passage 136, the apertures 154, 158 of FIGS. 4A and 4B are formed or cut in each ply 150 such that layering of the plies 150 can form the near wall cooling passage 136 of FIG. 3. It should be appreciated that aperture as used herein, unless expressly stated otherwise, can be representative of any hole, gap, space, slot, or similar, extending fully or partially through the ply 150 and having any cross-sectional shape or area, such that layering of the plies 150 forms the near wall cooling passage 136 of FIG. 3 having any designed geometry. While the plies 152, 156, 160 as discussed herein relate to individual plies, the can have similar applicability to a stack of plies 150, such as a layered set of more than one ply, such as between one and ten plies in one non-limiting example.

It should be understood that one ply 150 or any other ply described herein can be between 0.01 mm and 0.5 mm thick. Each individual ply can be pre-cut with a predetermined assembly, such that layering of the plies can form the shroud assembly 104 having the near wall cooling passage 136. The particular plies 150 can be particularly tailored to form the first and second portions 130, 132 of the shroud 104.

It should be appreciated that the second portion 132 of FIG. 3 encloses the near wall cooling passage 136. As such, layering of the plies 150 of the second portion 132 can enclose the near wall cooling passage 136 or a channel 142 thereof, as formed by the plies 150 within the first portion 130.

At completion, the near wall cooling passage 136, during operation, can provide a cooling airflow, such as an impinging airflow on the second portion 132 to cool the second portion 132, the inner face 106 thereof confronting the heated mainstream airflow M (FIG. 3). Utilizing multiple plies 150 to form the near wall cooling passage in the shroud 104 can reduce costs associated with typical drilling operations, while increasing yields. Furthermore, layering of the green-state plies 150 can provide for unique geometry for the near wall cooling passage 136, otherwise expensive or unachievable with conventional drilling operations.

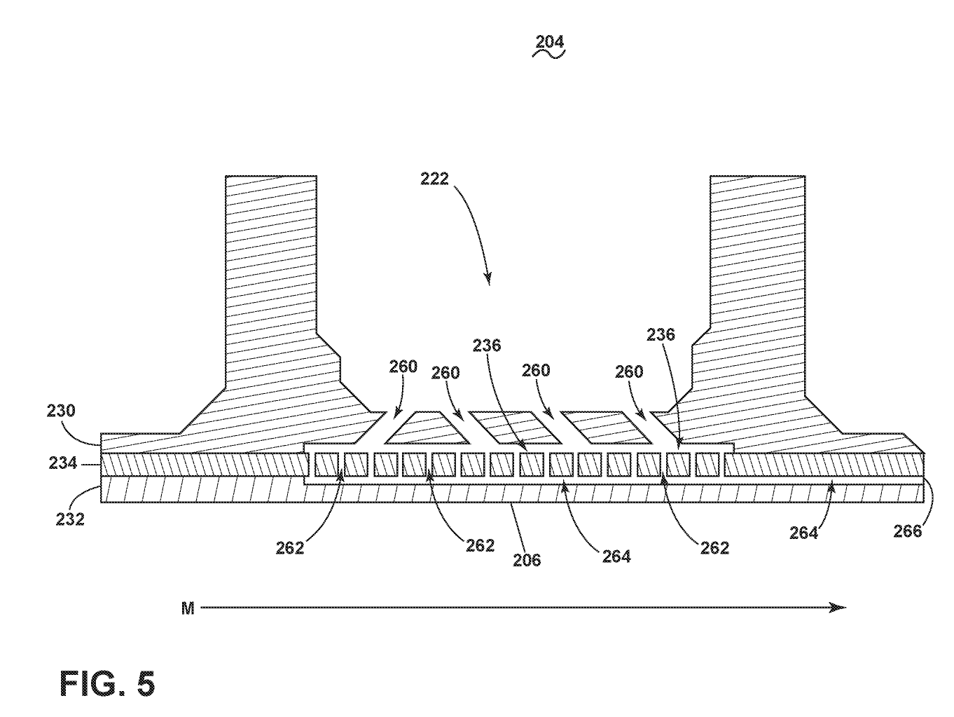

Referring now to FIG. 5, another exemplary shroud 204 is illustrated. The shroud 204 of FIG. 5 can be substantially similar to the shroud 104 of FIG. 3. As such, similar numerals will be used to identify similar elements increased by a value of one hundred and the discussion will be limited to the differences between the two.

The shroud 204 of FIG. 5 includes three portions, as a first portion 230, a second portion 232, and a third portion 234. The first portion 230 can be radially outside of the other two portions 232, 234, relative to the engine centerline, and the second portion 232 can be radially within the other two portions 230, 234. The third portion 234 can be provided between the first and second portions 230, 232. All portions 230, 232, 234 can be formed of CMC or by layering multiple plies, similar to that discussed above.

The shroud 204 can include a near wall cooling passage 236. The near wall cooling passage 236 can be made of multiple, discrete holes, apertures, channels, or the like, in non-limiting examples. The first portion 230 includes multiple inlet channels 260. The inlet channels 260, can be angled, as shown, or can be aligned with a radial axis relative to the engine centerline 12 (FIG. 1). Such an angled orientation can be any direction, such as axial, radial, circumferential, or any combination thereof, for example.

The second portion 232 can include a channel or groove 264 positioned opposite of an inner face 206. The groove 264 can have an outlet 266 for exhausting air from the near wall cooling passage 236.

The third portion 234 can include multiple holes 262. The holes 262 include a smaller cross-sectional area than that of the inlet channels 260, however, should not be so limited. The holes 262 can also be impingement holes, impinging on the groove 164 of the second portion 232. The inlet channels 260, holes 262, and the groove 264 can be in fluid communication, such that an airflow can be provided through the near wall cooling passage 236 from a shroud cavity 222 and exhaust through the outlet 266.

It should be appreciated that the near wall cooling passage 236 is exemplary as shown, and that the first, second or third portions 230, 232, 234 can have multiple different cooling features, including, in non-limiting examples, holes, channels, passages, grooves, or the like in any combination.

In operation, a flow of air is provided from the shroud cavity 222 and into the near wall cooling passage 236 at the inlet channels 260. The inlet channels 260 can provide the airflow to the holes 262 to provide the airflow to the second portion 232. The air exhausting from the holes 262 of the third portion 234 can impinge upon the second portion 232 at the groove 264 or otherwise, to cool the second portion 232 confronting the heated mainstream airflow M.

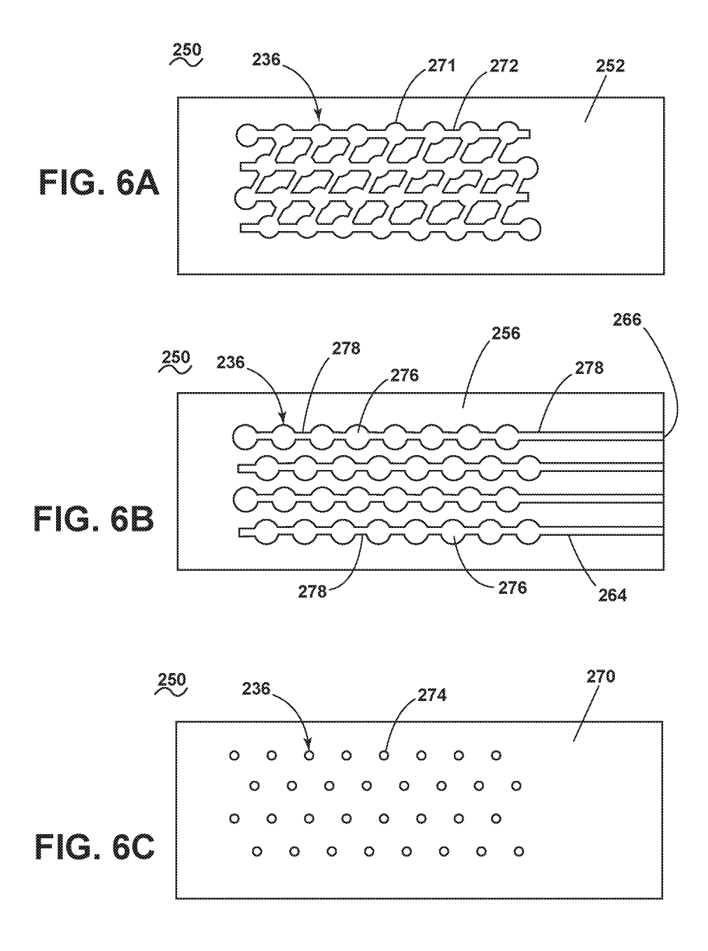

Referring now to FIGS. 6A-6C, three separate plies 250 are shown, with a first ply 252 (FIG. 6A) relating to the first portion 230 of FIG. 5, a second ply 256 (FIG. 6B) relating to the second portion 232 of FIG. 5, and a third ply 270 (FIG. 6C) relating to the third portion 234 of FIG. 5. The plies 250 include complex apertures, defining a complex near wall cooling passage 236 for the shroud assembly 204 of FIG. 5. The first ply 252 of FIG. 6A, includes apertures 271 for the inlet channels 260. Aperture channels 272 can be provided between and connecting at least some of the apertures 271. The aperture channels 272 fluidly couple the inlet channels 260 of FIG. 5 upon layering of a plurality of the first plies 252. The combined aperture channels 272 and the inlet channels 260 formed by layering the plies 252 can form a grid-like geometry for the first portion 230 of the shroud 204 as shown in FIG. 5. Thus, it should be appreciated that the apertures 271 in the plies 252 can form any geometry for the first portion 230 of FIG. 5, such that a flow of air is provided to the near wall cooling passage 236. It should be further appreciated that an increase in the inlet channels 260 and the aperture channels 272 can improve airflow to the near wall cooling passage 236, improve cooling effectiveness of the near wall cooling passage 236, as well as reduce overall weight.

FIG. 6B illustrates the second ply 256, which can partially form the second portion 232 of FIG. 5. The second ply 256 forms the grooves 264 of FIG. 5 with additional aperture channels 278. The aperture channels 278 having enlarged aperture portions 276, which can correspond to the inlet channels 260 of the first ply 252, for example. The enlarged aperture portions 276 provide for an enlarged impingement surface for cooling the second portion 232, while the aperture grooves 264 provide for exhausting of a cooling flow through the outlets 266.

FIG. 6C illustrates the third ply 270 comprising the third portion 234 of FIG. 5. The third ply 270 includes multiple apertures 274 formed in each ply 270. The apertures 274 can form the holes 262 of FIG. 5 when a plurality of the third plies 270 are layered onto one another. The apertures 274 can form impingement holes upon the stacking of the third plies 270. It should be appreciated that while the apertures 274 are shown in an organized manner, any organization of the apertures 274 is contemplated.

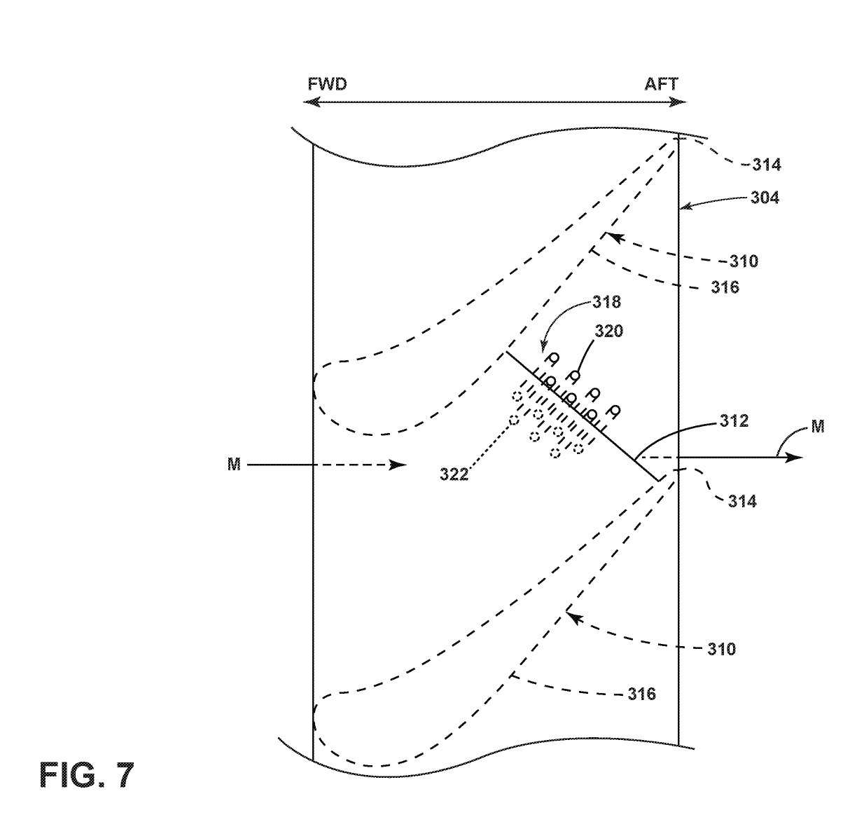

FIG. 7 illustrates a top view of another shroud assembly 304, having a set of airfoils 310 illustrated in phantom, which can be the blades 70 or the vanes 74 of FIG. 1, for example. As such, the shroud assembly 304 can be a shroud positioned radially exterior of the rotating blades, or an outer band mounted to stationary vanes. A throat 312 can be defined between the adjacent airfoils 310. The throat 312 can be the shortest distance between the adjacent airfoils 310, and can be the distance between a trailing end 314 of one airfoil 310 to a pressure side 316 of the adjacent airfoil 310, for example.

The shroud assembly 304 can include one or more near wall cooling passages 318. The near wall cooling passages 318 can include an inlet 320 and an outlet 322. The inlet 320 can be provided on a radially outer surface of the shroud assembly 304, while the outlet 322 can be provided on the radially inner surface of the shroud assembly 304 confronting the airfoil 310, such as the outer face 124 and the inner face 106 as described in FIG. 3, respectively. As such, the near wall cooling passages 318 can be used to provide a flow of cooling fluid from the radially outer area of the shroud assembly 304 to the radially inner area confronting a hot airflow, such as the mainstream airflow M.

The inlet 320 can be provided downstream, or on the aft side, of the throat 312, while the outlet 322 can be provided upstream, or forward of the throat 312. In this configuration, a flow of air provided to the near wall cooling passages 318 can be used to cool the shroud assembly 304, as well as to exhaust the cooling fluid upstream of the throat 312. As such, the near wall cooling passage 318 can exhaust a cooling fluid as a cooling film along the shroud assembly 304.

The mainstream flow M aft of the throat 312 is turbulent, and negatively impacts any cooling film exhausted into the turbulent flow. Exhausting the cooling flow from the near wall cooling passages 318 upstream of the throat 312 provides the cooling fluid at a less turbulent area, improving cooling film attachment and effectiveness. Thus, it should be appreciated that the near wall cooling passages as described herein can provide for cooling of the shroud assembly confronting a heated airflow and for providing a cooling film along the radial interior of the shroud assembly upstream of the throat 312.

Referring now to FIG. 8, a set of shroud segments 404 are positioned above a rotor assembly 410, which has a set of rotating blades 412 mounted on a rotating disk 414. The shroud segments 404 are arranged circumferentially surrounding the rotor assembly 410 and spaced from the blades 412. In one non-limiting example, one shroud segments 404 can encompass the space of two blades 412, while any size, spacing, or number of shroud segments 404 is contemplated. The shroud segments 404 include an inner face 406 facing the blades 412 and an outer face 408 opposite of the inner face 406. The shroud segment 404 can be split into a first portion 416 and a second portion 418, similar to that of FIG. 3. A split line 420 is formed at the junction between the adjacent shroud segments 404. A spline seal 422 can be provided in the split line 420 to prevent hot gas ingestion into the split line 420.

One or more near wall cooling passages 424 can be provided in the shroud segments 404, illustrated by way of example as one near wall cooling passage 424 on either side of each split line 420. The near wall cooling passages 424 include an inlet 426 and an outlet 428. The inlet 426 is provided on the outer face 408, while the outlet 428 exhausts to the split line 420. The outlet 428 can be positioned radially above or below the position of the spline seal 422 when placed within the split line 420, or at the spline seal 422.

In operation, an airflow can be provided to the near wall cooling passages 424 at the inlet 426. The near wall cooling passages 424 can be used to cool the inner face 406. Additionally, the near wall cooling passages 424 can exhaust at the outlet 428 to cool the split line 420, the spline seal 422, or minimize hot gas ingestion into the split line 420 from the mainstream hot air flow. Furthermore, the particular amount of air provided to the near wall cooling passages 424 and fed to the split line 420 can be tailored to pressurize the spline seal 422 within the split line 420 to further minimize hot gas ingestion. A balance can be struck between the airflow required to maintain pressure at the spline seal 422 with cooling of the shroud segment 404 along the inner face 406 from the near wall cooling passage 424.

While the discussion of the near wall cooling passage as described herein is directed to a shroud surrounding a rotating blade assembly, it should be understood that the near wall cooling passage as described herein can have equal applicability to additional portions of the peripheral wall defining the mainstream flow path M. Such portions can include an inner band or outer band of a stationary vane or nozzle assembly, or a platform or terminal surface of a disk. In the example of the outer band, the near wall cooling passage could be fed with a flow of air similar to that of the shroud as described herein. The near wall cooling passage in the outer band could exhaust to the mainstream flow, to the gap downstream of the band, or radially exterior of the outer band. The inner band could be fed with a flow of air from the outer band, passing through the interior of the vane or nozzle assembly. The near wall cooling passage in the inner band could exhaust to the mainstream flow M, the vanes, or not exhaust at all and return to the outer band. In the example of a platform for a rotating disk assembly, the near wall cooling passage could be fed with a flow of cooling air from the disk, similar to feeding air cooled blades in the turbine, or from an inlet originating form an interior face of the blade or blade platform. The near wall cooling passage in the platform could exhaust to the mainstream flow M on the platform, a shank pocket radially inboard of the platform, between shanks, or to an aft space between the disk and a downstream component, such as to a buffer cavity.

It should be appreciated that the aspects described herein provide for the routing of a flow of cooling fluid provides cooling near the surface of the shroud 104, 204 confronting a heated airflow, such as the inner faces 106, 206 described herein. The near wall cooling passages 136, 236 provide for improved cooling of the shroud 104, 204, which provides for higher engine temperatures and improved engine efficiency. The near wall cooling passages 136, 236 further provide for a means to direct a flow of air to the purge cavity or buffer cavity aft of the shroud. Additionally, the near wall cooling passage 136, 236 can provide cooling air to the spline, the spline seal, as well as forward of the nozzle throat 312. The shroud assembly or band assembly as described herein allows for reduced shroud, band, split line, or spline seal distress and reduced buffer cavity distress.

Additionally, utilizing the green-state plies and layering of such plies provide for the creation of numerous different near wall cooling passage designs within the shroud assembly, which can be particularly tailored to cool the shroud or band region as is desirable for the particular engine.

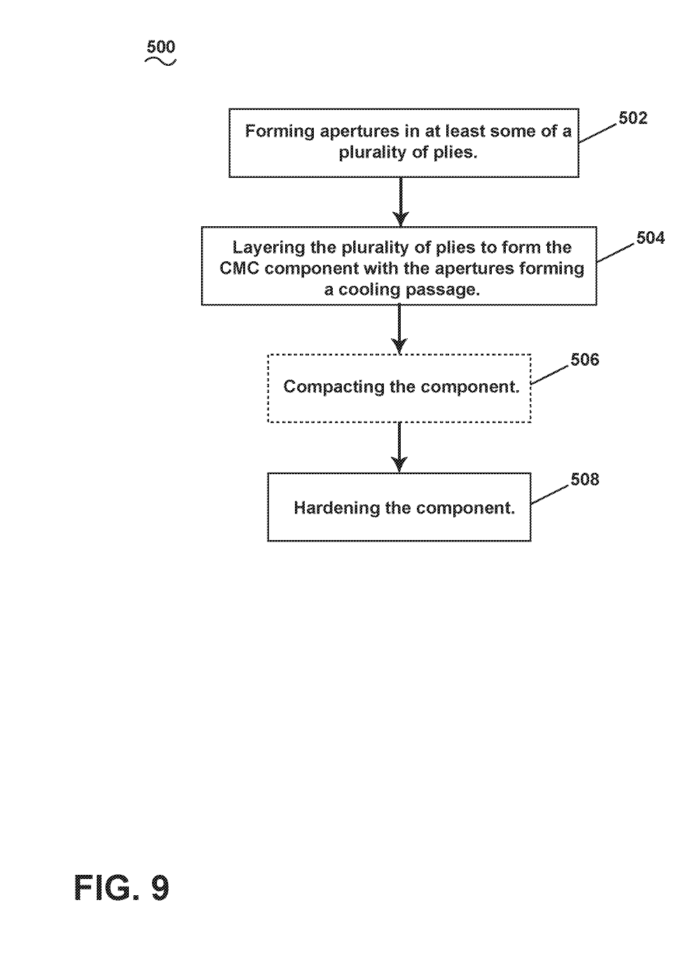

Referring now to FIG. 9, a flow chart illustrates a method 500 of manufacturing a component for a turbine engine can include (1) forming apertures in at least some of a plurality of plies at 502, (2) layering the plurality of plies to form the CMC component with the apertures forming a cooling passage at 504, and (3) hardening the component at 508. The method can optionally include compacting the component at 506. Compacting the component at 506 can occur before the hardening at 508.

The component can be a shroud such as the shroud assembly as described herein. Alternatively, the component can be any suitable component requiring near wall cooling and capable of formation by layering of multiple plies. Additional non-limiting examples can include an inner band or outer band for a nozzle, or an inner platform or terminal surface of a rotating disk. The method as described herein can further apply to forming additional engine components having near wall cooling passages, buy layering a plurality of particularly cut plies. The cooling passage formed by the layered apertures can define a near wall cooling passage, and can include any near wall cooling passage as described herein.

At step (1) shown at 502, apertures can be formed in a plurality of plies. The plurality of plies can be green-state CMC plies that are unhardened. At step (2) shown at 504, the plies having the apertures can be layered to form the CMC component with the layered apertures forming the cooling passage. Such apertures can be particularly adapted to form the specific desired geometry for the cooling passage. The apertures can form a near wall cooling passage at layering of the plies.

At step (3), hardening the component at 508 can include firing the component, for example. In another example, hardening the component at 508 can include sintering the component, while other methods such as chemical reaction or electrophoresis are contemplated.

It should be appreciated that application of the disclosed design is not limited to turbine engines with fan and booster sections, but is applicable to turbojets and turbo engines as well.

While the present disclosed design is discussed as being produced with ceramic or CMC components, or metal components, it should be appreciated that the shroud or other element having the near wall cooling passage can be made by additive manufacturing, such as 3D printing in one non-limiting example. It should be appreciated that additive manufacturing individual plies is also contemplated. In such an example, the thickness of the plies can be much smaller than that discussed previously. Additionally, additive manufacturing can enable formation of the complex near wall cooling passage as described herein.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A shroud assembly for a turbine engine having an engine centerline, the shroud assembly comprising:
at least one segment including a body having a forward face and an aft face, with a radially inner face facing the engine centerline and a radially outer face away from the engine centerline; and
a near wall cooling passage provided in the segment having an inlet provided in the outer face and an outlet.

2. The shroud assembly of claim 1 wherein the near wall cooling passage comprises multiple channels.

3. The shroud assembly of claim 1 wherein the segment comprises two ceramic matrix composite (CMC) portions mounted to one another and formed of layered CMC plies.

4. The shroud assembly of claim 3 wherein a radially outer portion of the two CMC portions includes apertures cut in the plies to form the near wall cooling passage.

5. The shroud assembly of claim 4 wherein a radially inner portion of the two CMC portions includes uncut plies to enclose the near wall cooling passage.

6. The shroud assembly of claim 4 wherein the apertures include discrete apertures formed in some of the plies to form the inlet and the outlet of the near wall cooling passage.

7. The shroud assembly of claim 6 wherein the apertures further include elongated apertures in some of the plies to form the near wall cooling passage.

8. The shroud assembly of claim 1 wherein the at least one segment includes multiple segments defining a split line between adjacent segments and the outlet fluidly couples the near wall cooling passage to the split line.

9. The shroud assembly of claim 1 wherein the outlet is provided on the inner face.

10. The shroud assembly of claim 1 wherein the outlet exhausts to a purge cavity aft of the shroud assembly.

11. The shroud assembly of claim 1 comprising a rotating blade assembly and a stationary vane assembly with an outer band, wherein the segment is one of a shroud segment facing the rotating blade assembly or the outer band.

12. A turbine engine comprising:
a compressor section, a combustion section, and a turbine section in axial arrangement and defining an engine centerline;
a blade assembly provided in at least one of the compressor section or the turbine section including a rotatable disk having a plurality of circumferentially arranged blades extending radially from the disk relative to the engine centerline;
a shroud assembly surrounding and spaced from the blade assembly and including multiple, circumferentially-arranged ceramic matrix composite (CMC) shroud segments with at least one shroud segment formed from a plurality of layered CMC plies with at least some of the plies having apertures; and
at least one near wall cooling passage formed by the apertures in the plurality of layered plies.

13. The turbine engine of claim 12 wherein the plurality of layered plies define a first radially outer portion of the at least one shroud segment and a second radially inner portion of the shroud segment, where the near wall cooling passage is formed in the first portion and the second portion encloses the near wall cooling passage.

14. The turbine engine of claim 13 wherein the plies defining the first radially outer portion include apertures and the plies defining the second radially inner portion do not include apertures.

15. The turbine engine of claim 13 wherein the at least one shroud segment further comprises a third portion formed from the plurality of layered CMC plies and provided between the first portion and the second portion.

16. The turbine engine of claim 15 wherein the plurality of layered CMC plies in comprising the third portion include a plurality of apertures to form impingement holes in the layered CMC plies.

17. The turbine engine of claim 12 wherein the near wall cooling passage includes an inlet and an outlet.

18. The turbine engine of claim 17 wherein the outlet fluidly couples the near wall cooling passage to a purge cavity downstream of the at least one shroud segment.

19. The turbine engine of claim 17 wherein a split line is formed at a junction between adjacent shroud segments and the outlet fluidly couples the near wall cooling passage to the split line.

20. The turbine engine of claim 17 wherein adjacent blades of the blade assembly define a throat, and the outlet of the near wall cooling passage is positioned upstream of the throat.

21. The turbine engine of claim 20 wherein the inlet is positioned downstream of the throat.

22. A method of manufacturing a ceramic matrix composite (CMC) component for a turbine engine, the method comprising:
forming apertures in at least some of a plurality of CMC plies;
layering the plurality of plies to form the CMC component with the apertures forming a cooling passage; and
hardening the component.

23. The method of claim 22 wherein the component is a shroud.

24. The method of claim 23 wherein the cooling passage is a near wall cooling passage.

25. The method of claim 22 wherein hardening the component comprises sintering the component.

26. The method of claim 22 further comprising compacting the component.

27. The method of claim 22 wherein the plurality of CMC plies are green-state CMC plies.

28. An engine component for a turbine engine including a compressor section, a combustor section, and a turbine section in axial arrangement defining a mainstream flow path providing a mainstream flow through the turbine engine, the engine component comprising:
a peripheral wall extending in an axial direction at least partially defining a circumferential perimeter of the mainstream flow path; and
a near wall cooling passage provided within the peripheral wall.

29. The engine component of claim 28 wherein the peripheral wall is a radially inner wall of an outer band provided in one of the compressor section or the turbine section.

30. The engine component of claim 28 wherein the peripheral wall is a radially outer wall of an inner band provided in one of the compressor section or the turbine section.

31. The engine component of claim 28 wherein the peripheral wall is a radially outer wall of an annular disk provided in one of the compressor section or the turbine section.

32. The engine component of claim 31 wherein the radially outer wall of the disk is a platform on a dovetail.

33. The engine component of claim 28 wherein the peripheral wall is a radially inner wall of a shroud for a rotating blade assembly in one of the compressor or turbine sections.
